(19) United States
(12) Patent Application Publication
(10) Pub. No.: US 2026/0316842 A1
(43) Pub. Date: Oct. 15, 2026

(54) Reinforcing Component for a Motor Vehicle Body, and Body Structure

(71) Applicant: Bayerische Motoren Werke Aktiengesellschaft, Muenchen (DE)

(72) Inventor: Dominic OFNER, Loiching (DE)

(21) Appl. No.: 19/463,565

(22) Filed: Jan. 29, 2026

(30) Foreign Application Priority Data
Jan. 30, 2025 (DE) 10 2025 103 484.2

(51) Int. Cl. B62D 25/04; B62D 25/08

(52) U.S. Cl. CPC B62D 25/04; B62D 25/088

(57) ABSTRACT

A reinforcing component for a motor vehicle body has a first fastening region, via which the reinforcing component can be fastened to a body construction element which projects in the forward vehicle longitudinal direction at a connection point from an A-pillar portion of an A-pillar of the motor vehicle body and via which a suspension strut support can be coupled to the A-pillar portion, and a second fastening region, via which the reinforcing component can be fastened to the A-pillar portion, covering at least some region or regions of the connection point in the vehicle transverse direction.

### CROSS REFERENCE TO RELATED APPLICATION

This application claims priority under 35 U.S.C. §119 from German Patent Application No. DE 10 2025 103 484.2, filed Jan. 30, 2025, the entire disclosure of which is herein expressly incorporated by reference.

### BACKGROUND AND SUMMARY

The invention relates to a reinforcing component for a motor vehicle body. Moreover, the invention relates to a body structure for a motor vehicle body having such a reinforcing component.

DE 10 2016 220 719 A1 discloses a motor vehicle having a body which forms a passenger cell, wherein the body has two lateral side rib structures, each with a front, lateral body pillar or A-pillar, wherein a front section is formed at one end of the body, and wherein the front section has, on each of the two sides, a suspension strut tower, a horizontally extending supporting member, which is arranged between the suspension strut tower and the respective A-pillar, and a supporting member extending between the suspension strut tower and a lower end of the A-pillar. In this case, the two supporting members and the A-pillar are composed of beam profiles in a shell-type configuration, wherein the respective triangular support structure is formed by said three beams.

It is the object of the invention to create a reinforcing component for a motor vehicle body as well as a body structure for a motor vehicle body, thus making it possible particularly to improve a stiffness of the motor vehicle body.

According to the invention, this object is achieved by a reinforcing component for a motor vehicle body and by a body structure for a motor vehicle body with such a reinforcing component in accordance with the independent claims. Advantageous refinements of the invention form the subject matter of the dependent patent claims and of the description.

A first aspect of the invention relates to a reinforcing component for a motor vehicle body, in particular for a body structure of the motor vehicle body. The motor vehicle body, in particular in its fully manufactured state, preferably has the reinforcing component. The motor vehicle body is understood, in particular, to mean a preferably self-supporting body for a motor vehicle or of the motor vehicle. The motor vehicle is designed as a passenger car, for example.

The motor vehicle is designed as an electrically drivable motor vehicle, for example. In other words, the motor vehicle has at least one electric machine by means of which the motor vehicle can be driven or is driven. In other words, the motor vehicle is designed as a battery-electric vehicle (BEV) or as a hybrid vehicle (PHEV). Alternatively, the motor vehicle is designed, for example, as a motor vehicle that can be driven or is driven by an internal combustion engine. This means that the motor vehicle has at least one internal combustion engine, for example, by means of which the motor vehicle can be driven or is driven.

In order to be able to particularly increase a stiffness of the motor vehicle body, the reinforcing component has at least one first fastening region, via which the reinforcing component can be fastened or is fastened, in particular directly, to a body construction element which projects in the forward vehicle longitudinal direction at a connection point from at least one A-pillar portion of an A-pillar of the motor vehicle body. In other words, the reinforcing component can be connected or is connected, in particular fixedly, to the body construction element via the first fastening region. The first fastening region is designed, for example, as a first fastening point, at which the reinforcing component can be fastened or is fastened, in particular directly, to the body construction element. The connection point is understood, in particular, to mean a connection point at which the body construction element rests, in particular directly, against the A-pillar portion. The body construction element is preferably connected, in particular directly, to the A-pillar portion at the connection point, that is to say, in particular, is fastened to the A-pillar portion. The statement that the body construction element projects from the A-pillar portion in the forward vehicle longitudinal direction is understood, in particular, to mean that the body construction element is, preferably directly, adjacent to the A-pillar portion in the forward vehicle longitudinal direction, in particular at the connection point, wherein the body construction element extends obliquely or perpendicularly to the A-pillar portion. The reinforcing component is designed to be separate from the body construction element and separate from the A-pillar portion, in particular separate from the A-pillar. The vehicle longitudinal direction is understood, in particular, to mean a vehicle longitudinal direction of the motor vehicle body and/or of the motor vehicle. The A-pillar portion is understood, in particular, to mean a construction element, such as a metal sheet, of the A-pillar.

Via the body construction element, a suspension strut support can be coupled or is coupled to the A-pillar portion, in particular mechanically. This means that the suspension strut support can be connected or is connected to the A-pillar portion, that is to say, in particular, to the A-pillar, via the body construction element. In other words, the suspension strut support can be supported or is supported by the A-pillar portion via the body construction element, in particular at least in the rearward vehicle longitudinal direction. The suspension strut support is understood, in particular, to mean an attachment region via which, in particular to which, at least one spring and/or damper element, which is designed as a suspension strut and/or as a shock damper for example, can be fastened or is fastened. By means of the spring and/or damper element, preferably at least one vehicle wheel of the motor vehicle can be coupled or is coupled, in particular in a sprung and/or damped manner, to the suspension strut support, that is to say, in particular via the suspension strut support, to the body structure or motor vehicle body. The vehicle wheel is understood, in particular, to mean a ground contact element of the motor vehicle. Accordingly, the motor vehicle can preferably be supported or is supported via the at least one vehicle wheel, in particular directly, on an underlying surface, e.g. a roadway, in the downward vehicle vertical direction. In particular, the vehicle wheel rolls on the underlying surface while the motor vehicle is being driven.

In order to be able to particularly increase the stiffness of the motor vehicle body, it is furthermore envisaged that the reinforcing component has at least one second fastening region, which is, in particular, spaced apart from the first fastening region and via which the reinforcing component can be fastened or is fastened, in particular directly, to the A-pillar portion, covering at least some region or regions of the connection point in the vehicle transverse direction, e.g. toward the inside or toward the outside. This means that the reinforcing component covers at least the connection point in the vehicle transverse direction when the reinforcing component is fastened to the A-pillar portion via the second fastening region, and is fastened to the body construction element, in particular via the first fastening region. In other words, the reinforcing component can be connected or is connected, in particular fixedly, to the A-pillar portion via the second fastening region, wherein the reinforcing component covers the connection point in the vehicle transverse direction or is designed to cover the connection point in the vehicle transverse direction. The second fastening region is designed, for example, as a second fastening point, at which the reinforcing component can be fastened or is fastened, in particular directly, to the A-pillar portion.

The body construction element is designed as a beam, for example, in particular as a longitudinal beam. The longitudinal beam is designed, for example, as an upper longitudinal beam, which is arranged further up in the vehicle vertical direction, for example, than a lower longitudinal beam, which is designed as a motor longitudinal beam, for example. In particular, the longitudinal beams are designed to be separate from one another.

The invention is based, in particular, on the following insights and considerations. From the time when batteries, in particular high-voltage batteries, were located structurally in bodies for battery-electric vehicles or hybrid vehicles, there was an enormous component lacking in the floor, for example, to contribute to body stiffness. Previously, for example, in particular for over 70 years, motor longitudinal beams in a sheet-steel body were extended in the floor like a ladder frame from the engine compartment, in particular in the rearward vehicle longitudinal direction, below the bulkhead in the vehicle vertical direction. These motor longitudinal beams are thus part of a load-bearing floor, for example, which can be referred to as a ladder frame. In order to install the battery on the motor vehicle, such motor longitudinal beams are removed or adapted, for example, such that, for example, they extend only as far as a bulkhead in the rearward vehicle longitudinal direction, and then as it were cease, for example. A region arranged in the floor, which has been created to accept the battery for example, is thus not optimal in respect of the stiffness of the motor vehicle body, for example, and this may entail disadvantages in respect of driving dynamics of the motor vehicle, for example.

In contrast, the disadvantages mentioned above can be avoided by means of the reinforcing component according to the invention. By means of the reinforcing component fastened to the body construction element via the first fastening region and fastened to the A-pillar portion via the second fastening region, the suspension strut support, that is to say, in particular, at least a load introduced into the motor vehicle body via the suspension strut support by the spring and/or damper element, can be supported via the reinforcing component, in particular at least in the rearward vehicle longitudinal direction, on the A-pillar portion, that is to say, in particular, on the A-pillar, thereby making it possible to particularly increase the stiffness of the motor vehicle body or body structure. This means that, by means of the reinforcing component, the suspension strut support, also referred to as a spring support, and/or a body front end, in particular a complete body front end, that is to say, for example, at least one force introduction point for a running gear into the body, can be supported in the direction of the A-pillar. As a result, a reinforced, in particular stiffened, body region, in particular body point, can be created since this body region can be reinforced, in particular stiffened, by means of the reinforcing component. Accordingly, the reinforcing component can be referred to as a stiffening component. By increasing the stiffness, it is possible to particularly improve driving-dynamic properties of the motor vehicle. Furthermore, crash requirements of the motor vehicle can be particularly improved. This means that safety, in particular safety in an accident involving the motor vehicle, can be particularly enhanced.

In particular, the reinforcing component is designed as an additional component, which may be understood, in particular, as a fitted component. Thus, the reinforcing component is preferably not a constituent part of the body shell but is preferably fitted, e.g. screwed on, during the vehicle assembly process only after the body shell has been painted. This additional component can be fitted to the body construction element via the first fastening region and fitted to the A-pillar portion via the second fastening region, in particular as required. As a result, the reinforcing component can be used, for example, for at least one construction variant, in particular specifically for one construction variant, which has, for example, particularly high or enhanced stiffness requirements relative to at least one further construction variant that may be referred to, for example, as the basic variant. The respective construction variant is understood, in particular, to mean a respective construction variant of the motor vehicle body and/or of the motor vehicle. A construction variant with enhanced stiffness requirements is, for example, a particularly sporty construction variant, that is to say, for example, a motor vehicle body provided for a sports car. By using the reinforcing component for specific construction variants it is possible to produce different construction variants of the motor vehicle body at particularly low cost.

The reinforcing component is designed, for example, as a reinforcing strut, which may also be referred to simply just as a strut or as an A-pillar strut.

Overall, it can be seen that body properties, in particular in conjunction with running gear components, can be particularly improved or at least maintained by means of the reinforcing component. In particular, it is possible by means of the reinforcing component to prevent the body, in particular a body front end, from losing stiffness on account of new geometries and/or body structures, especially in the case of battery-operated vehicles, and/or to prevent driving-dynamic properties, e.g. driving-dynamic accuracy, particularly in the lower, central and/or transverse-dynamic range, from being impaired.

In order to be able to particularly increase the stiffness of the motor vehicle body, it is envisaged in a further refinement that the reinforcing component has at least one third fastening region, which is, in particular, spaced apart from the first and the second fastening region and via which the reinforcing component can be fastened or is fastened, e.g. directly, to the A-pillar, in particular to a second pillar portion of the A-pillar different from said pillar portion. In other words, the reinforcing component can be connected or is connected, in particular directly, to the A-pillar, e.g. to the second pillar portion, via the third fastening region. As a result, the reinforcing component can be attached to the A-pillar in a manner that is particularly favorable in terms of loads. The second pillar portion is, for example, designed to be separate from the pillar portion that may be referred to as the first pillar portion. The third fastening region is designed, for example, as a third fastening point, at which the reinforcing component can be fastened or is fastened, in particular directly, to the A-pillar, in particular to the second pillar portion.

In order to be able to particularly increase the stiffness of the motor vehicle body, the second and the third fastening region are, in a further refinement, spaced apart in the vehicle vertical direction, that is to say, in particular, at least in the vehicle vertical direction. In other words, one of the pillar portions is designed as an upper pillar portion, and the other of the pillar portions is designed as a lower pillar portion. As a result, the reinforcing component can be attached to the A-pillar in a manner that is particularly favorable in terms of loads.

In order to be able to particularly increase the stiffness of the motor vehicle body, it is envisaged in a further refinement that the reinforcing component is, in particular at least substantially, of triangular design. This means that the reinforcing component is shaped in a triangular way. In other words, the reinforcing component has a triangular cross section, which may also be referred to simply just as a triangle. This means that the reinforcing component is designed as a triangle. As a result, the reinforcing component can be connected to the body construction element and to the A-pillar, in particular to the pillar portions, in a manner that is particularly favorable in terms of loads. As a result, the suspension strut can be supported on the A-pillar, in particular on the A-pillar portions, via the reinforcing component in a manner that is particularly favorable in terms of loads. For example, corners of the triangle are formed by the fastening regions, in particular the fastening points. In other words, the triangle or the triangular shape has three corners, wherein the first fastening region is arranged at a first of the corners, the second fastening region is arranged at a second of the corners, and the third fastening region is arranged at the third of the corners. The triangular cross section mentioned extends at least substantially perpendicularly to the vehicle transverse direction, for example.

In order to be able to particularly increase the stiffness of the motor vehicle body, in a further refinement the reinforcing component has a frame part, which connects the first and the second fastening region, in particular directly, and which may be referred to as the first frame part. This means that the first frame part is fastened to the first fastening region at one end, for example, and fastened to the second fastening region at the other end, for example. In other words, the first and the second fastening region are supported on one another via the first frame part, e.g. in the vehicle longitudinal direction and/or in the vehicle vertical direction. The first frame part preferably has a round, in particular circular, cross section. The first frame part has a hollow profile, for example. This means that the first frame part is, for example, of hollow design, in particular internally. Accordingly, the first frame part is designed, for example, as a tube, which may be referred to as the first tube.

In order to be able to particularly increase the stiffness of the motor vehicle body, it is envisaged in a further refinement that the reinforcing component has a frame part, which connects the first and the third fastening region, in particular directly, and which may be referred to as the second frame part. This means that the second frame part is fastened to the first fastening region at one end, for example, and fastened to the third fastening region at the other end, for example. In other words, the first and the third fastening region are supported on one another via the second frame part, e.g. in the vehicle longitudinal direction and/or in the vehicle vertical direction. The second frame part preferably has a round, in particular circular, cross section, which may be referred to as the second cross section. For example, the second frame part has a hollow profile, which may be referred to as the second hollow profile. This means that the second frame part is, for example, of hollow design, in particular internally. Accordingly, the second frame part is designed, for example, as a tube, which may be referred to as the second tube.

In order to be able to particularly increase the stiffness of the motor vehicle body, it is alternatively or additionally envisaged, for example, that the reinforcing component has a frame part, which connects the second and the third fastening region, in particular directly, and which may be referred to as the third frame part. This means that the third frame part is fastened to the second fastening region at one end, for example, and fastened to the third fastening region at the other end, for example. In other words, the second and the third fastening region are supported on one another via the third frame part, e.g. in the vehicle longitudinal direction and/or in the vehicle vertical direction. The third frame part preferably has a round, in particular circular, cross section, which may be referred to as the third cross section. For example, the third frame part has a hollow profile, which may be referred to as the third hollow profile. This means that the third frame part is, for example, of hollow design, in particular internally. Accordingly, the third frame part is designed, for example, as a tube, which may be referred to as the third tube.

Thus, the frame parts, that is to say, in particular, the first, the second and the third frame part, form, for example, a frame, in particular a triangular frame, and as a result the reinforcing component can be configured, for example, in a manner equivalent to a truss, that is to say, in particular, in a truss shape. As a result, the reinforcing component can be designed in a manner that is particularly favorable in terms of loads, in particular in a particularly weight-saving manner. Moreover, the reinforcing component can be configured in a particularly low-cost manner, thereby making it possible, for example, to keep a manufacturing outlay for the reinforcing component particularly low, thereby making it possible, in particular, to keep the manufacturing outlay for the motor vehicle body particularly low.

In order to be able to particularly increase the stiffness of the motor vehicle body, in particular in a manner that involves a particularly low outlay, in a further refinement the reinforcing component has a coupling element, via which the three frame parts, i.e. the first, the second and the third frame part, are connected to one another, in particular directly. In other words, the coupling element extends between the three frame parts, wherein the coupling element is connected, in particular directly, to the respective frame part, that is to say, in particular, is fastened to the respective frame part. The coupling element is thus designed, for example, as a closing element, which closes the abovementioned triangular cross section, for example. The coupling element is preferably designed as a metal sheet, which may also be referred to as a closing sheet or as a bulkhead sheet.

In order to be able to manufacture the motor vehicle body in a manner that involves a particularly low outlay, in a further refinement the reinforcing component has at least one through opening, in particular passing through the coupling element. For example, it is envisaged that, particularly in the case of dipping bath treatment, there can be a flow or is a flow of at least one dipping bath medium through the through opening. During dipping bath treatment, this enables the dipping bath medium to be drained from the body structure, in particular from the motor vehicle body, via the through opening, thereby enabling the dipping bath medium to flow off the body structure, in particular off the motor vehicle body, for example. It is thereby possible, for example, to avoid a situation where the dipping bath medium accumulates in cavities of the motor vehicle body. The dipping bath treatment is or comprises, for example, electrophoretic deposition, in particular cathodic dip coating (CDC). Accordingly, the dipping bath medium is, for example, a paint. Moreover, the through opening makes it possible to keep a weight of the reinforcing component particularly low.

In order to be able to particularly increase the stiffness of the motor vehicle body in a manner that is particularly favorable in terms of installation space, in a further refinement the reinforcing component is to be arranged or is arranged on the outside of the body construction element and of the pillar portion, and in particular of the second pillar portion, in the vehicle transverse direction. In other words, the reinforcing component covers the body construction element and the pillar portion and, in particular, the second pillar portion in the outward vehicle transverse direction, at least in some region or regions. As a result, the reinforcing component can be accommodated in a particularly space-saving manner in the motor vehicle body or motor vehicle.

A second aspect of the invention relates to a body structure, in particular a front end structure, for a motor vehicle body. The front end structure may be referred to as the front section. The motor vehicle body, in particular in its fully manufactured state, preferably has the body structure. The body structure has at least one reinforcing component according to the first aspect of the invention. In particular, the body structure has the A-pillar portion and the body construction element and, in particular, the suspension strut support. In particular, the reinforcing component is fastened, in particular directly, to the reinforcing part by the first fastening region and is fastened, in particular directly, to the A-pillar portion, via the second fastening region, wherein the reinforcing component covers at least the connection point in the vehicle transverse direction, e.g. toward the inside or toward the outside. Advantages and advantageous refinements of the first aspect of the invention may be regarded as advantages and advantageous refinements of the second aspect of the invention and vice versa.

Further features of the invention will become apparent from the claims, the figures and the description of the figures. The features and combinations of features mentioned above in the description as well as the features and combinations of features mentioned below in the description of the figures and/or shown in the figures alone can be used not only in the respectively indicated combination but also in other combinations or in isolation.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic partially sectioned view of a motor vehicle having a body structure according to an embodiment of the invention;

FIG. 2 is a schematic and perspective partial view of the motor vehicle body having the body structure;

FIG. 3 is a schematic and perspective partial view of the body structure according to an embodiment of the invention;

FIG. 4 is a schematic and perspective partially sectioned view of the body structure;

FIG. 5 is a schematic partial side view of the body structure.

In the figures, identical elements or functionally identical elements are provided with the same reference signs.

### DETAILED DESCRIPTION OF THE DRAWINGS

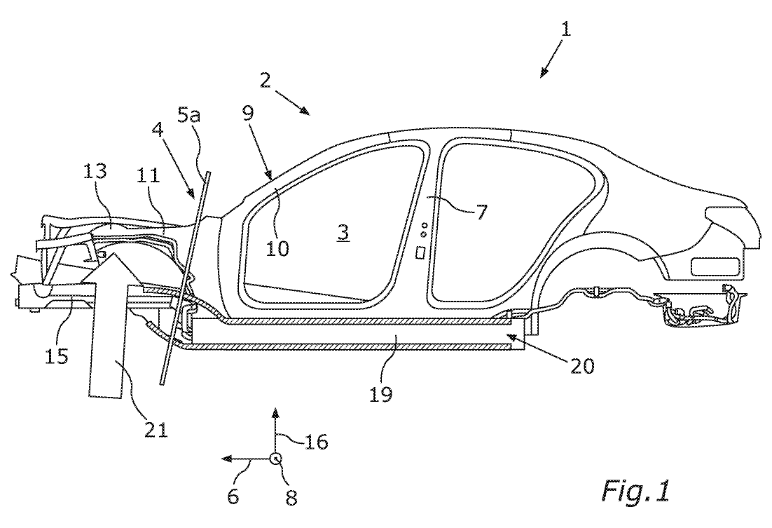

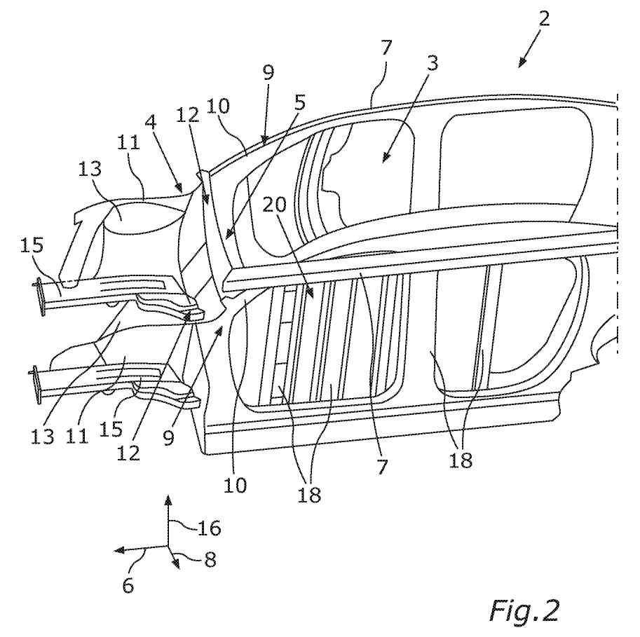

FIG. 1 shows a schematic partially sectioned side view of a motor vehicle 1, which is designed as a passenger car, for example. Accordingly, FIG. 1 shows a section of the motor vehicle 1. The motor vehicle 1 has a motor vehicle body 2, which is preferably designed as a self-supporting body. The body is understood, in particular, to mean a body shell, which may also be referred to as a body-in-white. In FIG. 2, the motor vehicle body 2 is illustrated in a schematic and perspective partial view. The motor vehicle body 2 at least partially, in particular predominantly or completely, delimits an interior 3 of the motor vehicle 1.

The motor vehicle body 2 has a body structure 4, which is designed, for example, as a front end structure, which may also be referred to simply just as a front end. For example, the body structure 4 has at least one bulkhead structure 5, which in particular has a bulkhead. The bulkhead structure 5, in particular the bulkhead, at least partially delimits the interior 3 in the forward vehicle longitudinal direction 6. A transition 5a between an engine compartment or the front end and the bulkhead is illustrated in FIG. 1. Moreover, the motor vehicle body 2 has, for example, at least one side frame 7, which at least partially delimits the interior 3 in the outward vehicle transverse direction 8. The motor vehicle body 2 preferably has two such side frames 7, which are spaced apart in the vehicle transverse direction 8 and, for example, are connected to one another at least via the bulkhead structure 5.

In addition, the motor vehicle body 2, in particular the body structure 4, has at least one A-pillar 9, which is formed, in particular, by the side frame 7. The motor vehicle body 2, in particular the body structure 4, preferably has two such A-pillars 9, which are spaced apart, in particular, in the vehicle transverse direction 8. The A-pillar 9, in particular the respective A-pillar 9, has at least one pillar portion 10.

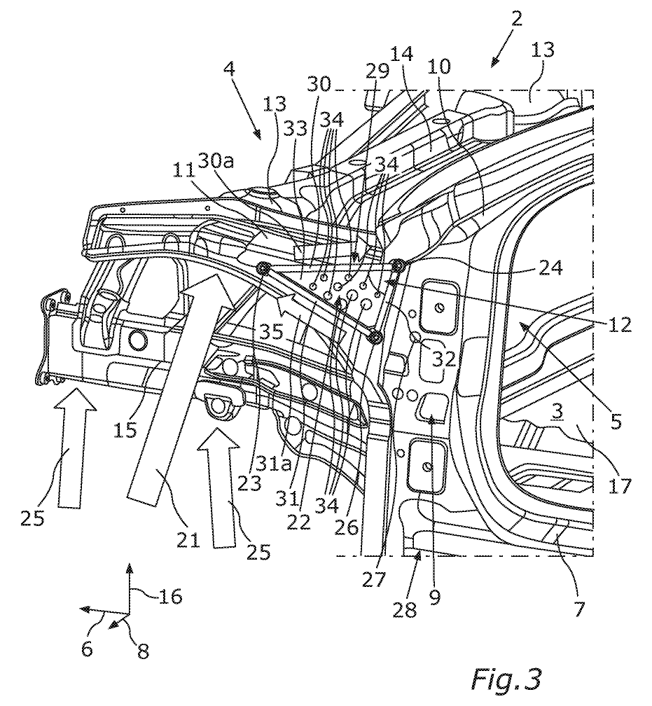

In FIGS. 2 and 3, the body structure 4 is shown in a schematic and perspective partial view. As can be particularly clearly seen in FIGS. 2 and 3, the body structure 4 has a body construction element 11 which projects in the forward vehicle longitudinal direction 6, in particular directly, e.g. obliquely or perpendicularly, from the A-pillar portion 10 at a connection point 12. At this connection point 12, the body construction element 11 is, for example, fastened to the pillar portion 10, in particular directly. The body construction element 11 is designed as a beam, for example, in particular as a longitudinal beam.

For example, the motor vehicle body 2, in particular the body structure 4, has two such body construction elements 11, which are spaced apart in the vehicle transverse direction 8 and, for example, are connected to one another at least via the bulkhead structure 5. This means that, for example, the body structure 4 has two respective body construction elements 11, which project from the respective A-pillar portion 10 in the forward vehicle longitudinal direction 6 at the respective connection point 12.

In addition, the body structure 4 has at least one suspension strut support 13, preferably two suspension strut supports 13. Moreover, the, in particular respective, suspension strut support 13 can be coupled or is coupled to the A-pillar portion 10 via the body construction element 11 or via the respective body construction element 11. Via the, in particular respective, suspension strut support 13, at least one, in particular respective, spring and/or damper element can be coupled or is coupled to the body structure 4, for example, said element being designed, for example, as a suspension strut and/or as a shock damper. For example, the, in particular respective, suspension strut support 13 is designed as a, in particular respective, suspension strut tower. The, in particular respective, suspension strut support 13 can be designed to be separate from the, in particular respective, body construction element 11 or can be formed by the, in particular respective, body construction element 11, as a result of which the, in particular respective, body construction element 11 can have the, in particular respective, suspension strut support 13. For example, the body construction elements 11, in particular the suspension strut supports 13, can be connected to one another via at least one crossmember 14.

For example, the body structure 4 has at least one longitudinal beam 15, which projects in the forward vehicle longitudinal direction 6 from the bulkhead structure 5 and/or from the A-pillar 9 and which is designed as a motor longitudinal beam, for example. Two such longitudinal beams 15 are preferably provided. Thus, for example, the body structure 4 has two longitudinal beams 15, which each project in the forward vehicle longitudinal direction 6 from the bulkhead structure 5 and/or from the A-pillar 9 and, in particular, are spaced apart in the vehicle transverse direction 8. For example, the, in particular respective, longitudinal beam 15 is arranged further up in the vehicle vertical direction 16 than the, in particular respective, longitudinal beam 15, which may also be referred to as a lower longitudinal beam.

Moreover, the motor vehicle body 2 has, for example, a floor structure which has, for example, at least one floor element 17, which at least partially delimits the interior 3 in the downward vehicle vertical direction 16. In addition, the floor structure has, for example, at least one floor crossmember 18, in particular a plurality of floor crossmembers 18. For example, at least one of these floor crossmembers 18 or a plurality of the floor crossmembers 18 is designed as a seat crossmember, to which, for example, at least one seat abutment of the motor vehicle 1 can be fastened or is fastened. The seat crossmember or crossmembers does not or do not have a load-bearing function for the motor vehicle body 2.

Moreover, the longitudinal beams 15 reach only as far as the bulkhead structure 5 in the rearward vehicle longitudinal direction 6, for example, as a result of which, in particular, the longitudinal beams 15 do not extend behind the bulkhead structure 5 in the vehicle longitudinal direction 6. This means that, for example, a longitudinal beam extension of the longitudinal beams 15 is eliminated, i.e. is not provided. As a result, an installation space 20 provided for an electric energy storage device 19, in particular in the floor region, is preserved. Accordingly, the electric energy storage device 19 is designed, in particular, as an underfloor storage device, e.g. as an underfloor battery. For example, the electric energy storage device 19 is arranged below the floor element 17 in the vehicle vertical direction 16. The electric energy storage device 19 is understood, in particular, to mean a battery or a rechargeable battery. For example, the electric energy storage device 19 is designed as a high-voltage component, in particular as a high voltage battery. For example, the motor vehicle body 2, in particular the body structure 4, has at least one attachment point, via which the electric energy storage device 19 can be fastened or is fastened, in particular at least indirectly or directly, to the motor vehicle body 2, in particular to the body structure 4.

Owing to the arrangement, that is to say location, of the electric energy storage device 19 in the floor of the motor vehicle body 2, the longitudinal beams 15 are, for example, implemented structurally only as far as the bulkhead structure 5, in particular the bulkhead, in the vehicle longitudinal direction 6. This has a massive effect, for example, on a stiffness of the body structure 4, in particular of a body front end. For example, the body structure 4, also referred to as the front end region, is particularly highly stressed by force introduction 21 via the spring and/or damper elements and/or axle systems, particularly in the region of the bulkhead, that is to say, for example, at the previously mentioned transition 5a, and is thereby particularly severely weakened there, for example. In addition, there is the fact, for example, that forces which arise on account of an additional weight caused by the electric energy storage device 19 and which are introduced into the motor vehicle body 2, may be particularly increased. This has a serious effect on the driving behavior of the motor vehicle 1, e.g. in all speed ranges. However, for a particularly sporty body setup and/or running gear setup and, in particular, to enhance performance, as in the case, for example, of a particularly sporty vehicle, a stiff or particularly stiff motor vehicle body 2 is required, particularly in an ideal case.

In order to be able to particularly increase a stiffness of the motor vehicle body 2, in particular of the body structure 4, the body structure 4 has at least one reinforcing component 22, which has a first fastening region 23, by which, in particular at which, the reinforcing component is fastened to the body construction element 11. In addition, the reinforcing component 22 has a second fastening region 24, via which the reinforcing component 22 is fastened to the A-pillar portion 10, in particular so as to cover at least the connection point 12 in the vehicle transverse direction 8, at least in some region or regions. As a result, the suspension strut support 13 in particular can be supported or is supported on the A-pillar portion 10, preferably at least in the rearward vehicle longitudinal direction 6, by way of the body construction element 11 via the reinforcing component 22, in particular in addition to support of the body construction element 11 on the A-pillar portion 10 which is effected via the connection point 12. The body structure 4 in particular is thereby reinforced, in particular stiffened, by the reinforcing component 22. It is thus possible by means of the reinforcing component 22 to counteract body deformation, in particular by screwing the reinforcing component 22 to the motor vehicle body 2.

Accordingly, the reinforcing component 22 is designed, for example, as a strut which has at least two attachment points for attachment to the motor vehicle body 2 in the form of the fastening regions 23, 24. By means of the reinforcing component 22 as a fitted part, which can be referred to, in particular, as an auxiliary frame, it is possible deliberately to enormously enhance driving-dynamic properties and/or performance between the motor vehicle body 2 and running gear components, e.g. the spring and/or damper element, e.g. since it is possible to counteract deformation of the motor vehicle body 2 in the front end region by way of a force introduction point of a shock damper mount relative to the A-pillar 9. This shock damper mount is, in particular, the suspension strut support 13 mentioned. Behind the A-pillar 9 in the vehicle transverse direction 8, in particular behind the pillar portion 10, there is, for example, at least one high-strength material, which is fixedly connected to the rest of the body structure in order to meet crash requirements, for example.

The reinforcing component 22 is designed to be separate from the body construction element 11 and separate from the A-pillar 9, in particular from the A-pillar portion 10. The fastening of the reinforcing component 22 to the body construction element 11 via the first fastening region 23 is accomplished by means of at least one screwed joint, for example. The fastening of the reinforcing component 22 to the pillar portion 10 via the second fastening region 24 is accomplished by means of at least one screwed joint, for example.

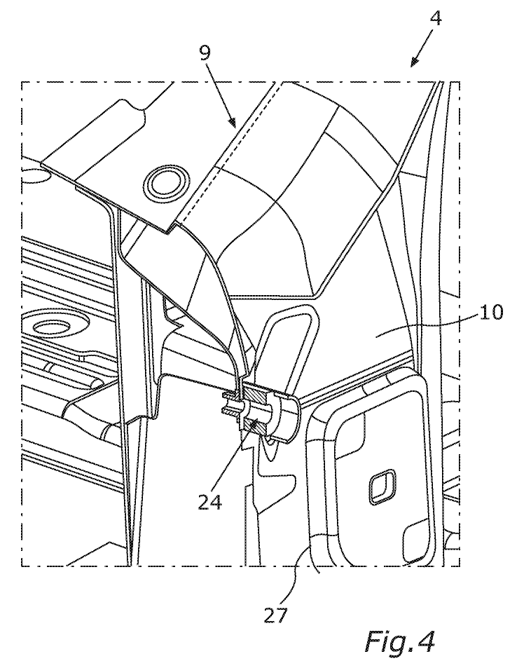

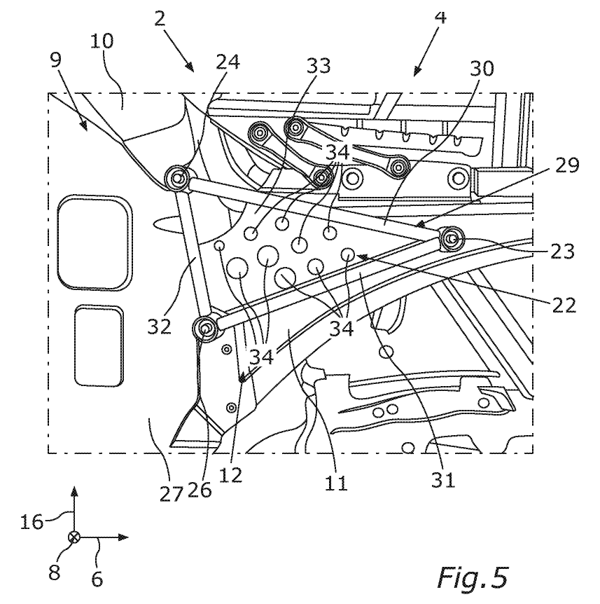

In FIG. 4, the body structure 4 is shown in a schematic partially sectioned view, wherein the second fastening region 24 is illustrated here. In FIG. 5, the body structure 4 is shown in a schematic partial side view.

The force introduction 21 results, for example, from the shock damper, for which reason the force introduction 21 may also be referred to as shock damper force. Further force introductions 25 result, for example, from an axle beam, for which reason the further force introductions 25 may also be referred to as axle beam forces. It is thus possible, in particular on account of the further force introductions 25, for there to be a load introduction from the axle beam into the motor vehicle body 2, in particular into the body structure 4. For this purpose too, it is advantageous if the body structure is of particularly stiff design, and this can be achieved by means of the reinforcing component 22.

The reinforcing component 22 preferably has a third fastening region 26, via which the reinforcing component 22 is fastened to the A-pillar 9, in particular to a second pillar portion 27 of the A-pillar 9, which is different from the pillar portion 10. The fastening of the reinforcing component 22 to the second pillar portion 27 via the third fastening region 26 is accomplished by means of at least one screwed joint, for example.

Thus, the reinforcing component 22 forms, for example, a fastening which is in addition to the connection point 12 via which the body construction element 11 and the A-pillar 9, in particular the pillar portion 10, are connected to one another and via which the body construction element 11 and the A-pillar 9, in particular the pillar portion 10 and/or the second pillar portion 27, are connected to one another, e.g. directly.

In the present case, the second and the third fastening region 24, 26 are spaced apart in the vehicle vertical direction 16. In the exemplary embodiment, the third fastening region 26 is arranged further down than the second fastening region 24 in the vehicle vertical direction 16. As a result, in the present case the pillar portion 10, which may be referred to as the first pillar portion, can be arranged above, in particular directly above, the second pillar portion 27 in the vehicle vertical direction 16, and the pillar portion 10 may therefore be referred to as the upper pillar portion and the pillar portion 27 may be referred to as the lower pillar portion. For example, the pillar portion 10 has at least one attachment region for fastening a front window to the A-pillar 9. This means that the front window can be fastened or is fastened to the A-pillar 9 via the attachment region of the pillar portion 10, e.g. by means of at least one adhesive joint, in particular at least indirectly or directly. The front window is understood, in particular, to mean a windshield. In particular, the pillar portion 10 extends further up than the longitudinal beam 15 in the vehicle vertical direction 16. In particular, the second pillar portion 27 extends further down than the body construction element 11 in the vehicle vertical direction 16. For example, the second pillar portion 27 extends down as far as a rocker 28 in the vehicle vertical direction 16.

For example, the second fastening region 24 is arranged behind the third fastening region 26 in the vehicle longitudinal direction 6. In the present case, the second and the third fastening region 24, 26 are arranged further back than the first fastening region 23 in the vehicle longitudinal direction 6. For example, the second fastening region 24 is arranged further up than the first fastening region 23 in the vehicle vertical direction 16. For example, the third fastening region 26 is arranged lower than the first fastening region 23 in the vehicle vertical direction.

As is particularly clear in FIGS. 3 and in 5 , the reinforcing component 22 is of triangular design in the exemplary embodiment. In the present case, the reinforcing component 22 furthermore has a frame 29 which, in the present case, has three frame parts 30, 31, 32. A first of the frame parts 30 connects the first and the second fastening region 23, 24 to one another, in particular directly. In the present case, a second of the frame parts 31 furthermore connects the first and the third fastening region 23, 26 to one another, in particular directly. In the present case, the third of the frame parts 32 furthermore connects the second and the third fastening region 24, 26 to one another, in particular directly. Thus, for example, the frame parts 30, 31, 32 form a triangle, that is to say, in particular, a triangular shape. In this case, the fastening regions 23, 24, 26 form the corners of this triangle, for example. This means that one of these corners in each case is formed by the respective fastening region 23, 24, 26.

For example, the respective frame part 30, 31, 32 in each case has a round cross section, as a result of which the respective frame part 30, 31, 32 is designed as a respective tube, for example.

For example, a load introduction into the body structure 4, in particular via the suspension strut support 13 is associated with a compression load 30a on the first frame part 30 and/or a tensile load 31a on the second frame part 31. The compression load 30a is understood, in particular, to mean a compression force. The tensile load 31a is understood, in particular, to mean a tensile force. In particular, this compressive load 30a and/or tensile load 31a result/results from the force introduction 21 and/or from the further force introductions 25.

As is particularly clear in FIGS. 3 and 5 , in the present case the reinforcing component 22 has, for example, a coupling element 33, in particular a coupling element formed separately from the frame 29, which, in particular, extends within the frame 29. For example, the three frame parts 30, 31, 32 are connected to one another, in particular directly, via the coupling element 33. In particular, the coupling element 33 closes the frame 29, that is to say, in particular, at least one opening formed by the frame 29, at least partially, in particular at least predominantly. The coupling element 33 is, for example, designed as a metal sheet, which may also be understood, in particular, as a bulkhead sheet. Thus, for example, the reinforcing component 22 is designed as a three-point tubular structure, as a truss, in particular with a bulkhead sheet.

For example, the reinforcing component 22 is arranged on the outside of the body construction element 11 and of the pillar portion 10, in particular the second pillar portion 27, in the vehicle transverse direction 8. Accordingly, the reinforcing component 22 is, for example, screwed into the body structure 4 of the motor vehicle body 2 from the outside in the vehicle transverse direction 8 in order, for example, to reinforce a weakened body region again and, in particular, to achieve a body which is as stiff as possible and which, in particular, transfers introduced forces particularly well or better in order, for example, to achieve a direct or more direct and safer or particularly safe driving sensation, that is to say, in particular to improve, said driving sensation.

For example, the reinforcing component 22 is covered from the outside in the vehicle transverse direction 8 by at least one covering element, e.g. a trim component. This covering element is designed, for example, as a side wall, in particular as a front side wall. Thus, the reinforcing component 22 is, in particular, not visible from the outside. This means that the reinforcing component 22 is, for example, designed as a strut which is not visible from the outside and/or as a fitted part which is not visible from the outside and which, in particular, is situated behind or below the side wall relative to the vehicle transverse direction 8.

For example, the reinforcing component 22, in particular the coupling element 33, has at least one through opening 34, which is provided or designed for the removal, in particular flowing away, of at least one dipping bath medium in the case of dipping bath treatment of the motor vehicle body 2. This enables the dipping bath medium to flow away from the body structure 4, in particular from the motor vehicle body 2, via the through opening 34, thereby making it possible, for example, to dispense with manual removal of the dipping bath medium from the motor vehicle body 2. As a result, the dipping bath medium can be removed with particularly little effort, thereby making it possible, for example, to keep an outlay on the manufacture of the motor vehicle body 2 particularly low. A plurality of such through openings 34 is preferably provided, e.g. at least two, at least five or at least 8.

The body structure 4 preferably has two such reinforcing components 22, which are, in particular, of identical design. Thus, for example, each of the respective reinforcing components 22 has the respective first fastening region 23, via which the respective reinforcing component 22 is fastened, in particular at the respective connection point 12, to the respective body construction element 11, which projects in the forward vehicle longitudinal direction 6 from the respective pillar portion 10 of the A-pillar 9, at which element, in particular, the respective suspension strut support 13 can be coupled or is coupled to the respective A-pillar portion 10. In addition, each of the respective reinforcing components 22 has a respective second fastening region 24, via which the respective reinforcing component 22 is fastened to the respective A-pillar portion 10, in particular so as to cover the respective connection point 12 in the vehicle transverse direction 8. In addition, each of the reinforcing components 22 has, for example, the respective third fastening region 26, via which the respective reinforcing component 22 is fastened to the respective second pillar portion 27.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 motor vehicle
2 motor vehicle body
3 interior
4 body structure
5 bulkhead structure
5a transition
6 vehicle longitudinal direction
7 side frame
8 vehicle transverse direction
9 A-pillar 10 first pillar portion
11 body construction element
12 connection point
13 suspension strut support
14 crossmember
15 longitudinal beam
16 vehicle vertical direction
17 floor element
18 floor crossmember
19 electric energy storage device
20 installation space
21 force introduction
22 reinforcing component
23 first fastening region
24 second fastening region
25 further force introduction
26 third fastening region
27 second pillar portion
28 rocker
29 frame
30 first frame part
30a compressive load
31 second frame part
31a tensile load
32 third frame part
33 coupling element
34 through opening

What is claimed is:

1. A component for a motor vehicle body, comprising:
a reinforcement component comprising
a first fastening region, via which the reinforcing component is fastenable to a body construction element which projects in a forward vehicle longitudinal direction at a connection point from an A-pillar portion of an A-pillar of the motor vehicle body and via which a suspension strut support is couplable to the A-pillar portion; and
a second fastening region, via which the reinforcing component is fastenable to the A-pillar portion, covering at least some region or regions of the connection point in a vehicle transverse direction.

2. The component according to claim 1, further comprising:
a third fastening region, via which the reinforcing component is fastenable to a second pillar portion of the A-pillar, which second pillar portion is different from the pillar portion.

3. The component according to claim 2, wherein
the second and the third fastening region are spaced apart in a vehicle vertical direction.

4. The component according to claim 1, wherein
the reinforcing component has a triangular shape.

5. The component according to claim 1, further comprising:
a first frame part, which connects the first and the second fastening region and which has a round cross section.

6. The component according to claim 2, further comprising:
a first frame part, which connects the first and the second fastening region and which has a round cross section.

7. The component according to claim 6, further comprising:
a second frame part, which connects the first and the third fastening region and which has a round cross section, and/or
a third frame part, which connects the second and the third fastening region and which has a round cross section.

8. The component according to claim 7, further comprising:
a coupling element, via which the first, second and third frame parts are connected to one another, wherein the coupling element is formed as a metal sheet.

9. The component according to claim 8, wherein
the coupling element has at least one through opening in the metal sheet.

10. The component according to claim 1, wherein
the reinforcing component is to be arranged on an outside of the body construction element and of the pillar portion in the vehicle transverse direction.

11. A motor vehicle body, comprising:
a body structure for the motor vehicle body; and
at least one component according to claim 1.
